(19) United States
(12) Patent Application Publication
(10) Pub. No.: US 2014/0365700 A1
(43) Pub. Date: Dec. 11, 2014

(54) EXPANSION BOARD FOR MEMORY CARDS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: ZHAO-YANG CAI, Shenzhen (CN); ZHENG-QUAN PENG, Shenzhen (CN); HAI-QING ZHOU, Shenzhen (CN); YI-XIN TU, Shenzhen (CN)

(21) Appl. No.: 14/300,408

(22) Filed: Jun. 10, 2014

(30) Foreign Application Priority Data
Jun. 11, 2013 (CN) 201310230229X

(51) Int. Cl. G06F 13/40

(52) U.S. Cl. CPC G06F 13/409
USPC 710/301

(57) ABSTRACT

An expansion board that can be inserted into a first memory slot is provided. The expansion board includes a circuit board, a number of second memory slots, a frequency divider, and an edge connector. The second memory slots and the frequency divider are arranged on the circuit board. The edge connector is set on a side of the circuit board to engage in the first memory slot. The second memory slots and the frequency divider are coupled to the edge connector, to communicate with the first memory slot via the edge connector.

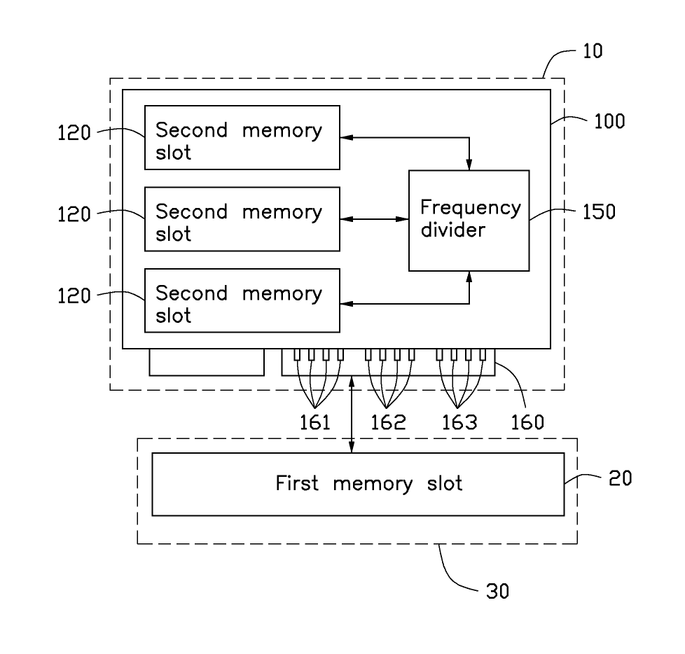

### FIELD

The subject matter herein generally relates to an expansion board for memory cards.

### BACKGROUND

Extra memory slots are arranged on a motherboard for additional memory to be added if required.

### BRIEF DESCRIPTION OF THE DRAWINGS

Implementations of the present technology will now be described, by way of example only, with reference to the attached FIGURE, wherein:

The FIGURE is a schematic diagram of an embodiment of an expansion board for memory cards of the present disclosure.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure is described in relation to an expansion board for memory cards.

The drawing illustrates an embodiment of the expansion board 10. The expansion board 10 can be inserted into a first memory slot 20 of a motherboard 30. The expansion board 10 can comprise a circuit board 100, three second memory slots 120, and a frequency divider 150. The second memory slots 120 and the frequency divider 150 are arranged on the circuit board 100. The frequency divider 150 is coupled to the second memory slots 120. An edge connector 160 is set on a side of the circuit board 100, to be engaged in the first memory slot 20 of the motherboard 30. The second memory slots 120 and the frequency divider 150 are coupled to the edge connector 160, to communicate with the first memory slot 20 via the edge connector 160. The edge connector 160 can comprise power pins 161, signal pins 162, and ground pins 163. When the edge connector 160 is engaged in the first memory slot 20, the power pins 161 are coupled to the first memory slot 20 for transferring power from the motherboard 120 to the second memory slots 120 and the frequency divider 150, and the ground pins 163 are coupled to a ground layer of the motherboard 30. When the edge connector 160 is engaged in the first memory slot 20, the signal pins 162 are coupled to the first memory slot 20 for exchanging memory data between the second memory slots 120 and the first memory slot 20. The frequency divider 150 is used to transfer and distribute the memory data.

In the embodiment, memory cards or another expansion board can be inserted into the second memory slots 120.

In use, three memory cards can be inserted into the second memory slots 120 respectively. The expansion board 10 is inserted into the first memory slot 20 via the edge connector 160. When the motherboard 30 is powered on, the memory cards, which are inserted into the second memory slots 120 and the frequency divider 150, receive power from the motherboard 30 via the power pins 161 of the edge connector 160. Then the frequency divider 150 transfers and distributes the memory data from the motherboard 30 to the memory cards via the signal pins 162 of the edge connector 160. The motherboard 30 receives the memory data from the memory cards through the second memory slots 120, the signal pins 162 of the edge connector 160, and the first memory slot 20. Thus, the memory cards, which are inserted into the second memory slots 120, can communicate with the motherboard 30.

In other embodiments, the number of the second memory slots depends on support ability of a control chip of the motherboard 30.

The expansion board 10 can reduce the number of the first memory slots on the motherboard 30.

The embodiment shown and described above is illustrative of the subject matter of this disclosure. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An expansion board configured to be inserted into a first memory slot of a motherboard, the expansion board comprising:
a circuit board;
at least one second memory slot arranged on the circuit board;
a frequency divider arranged on the circuit board and configured to transfer and distribute memory data; and
an edge connector set on a side of the circuit board configured for engaging insertion in the first memory slot;
wherein the second memory slot and the frequency divider are coupled to the edge connector, thereby enabling communication with the motherboard at the first memory slot via the edge connector.

2. The expansion board of claim 1, wherein the edge connector comprises a power pin and a signal pin, when the edge connector is engaged in the first memory slot, the power pin is coupled to the first memory slot for transferring power to the second memory slot and the frequency divider, and the signal pin is coupled to the first memory slot for exchanging memory data between the second memory slot and the first memory slot.

3. The expansion board of claim 1, wherein a memory is inserted in the second memory slot.

4. The expansion board of claim 1, wherein another expansion board is inserted in the second memory slot.

5. The expansion board of claim 1, wherein the number of the second memory slots is three.
